(19) United States
(12) Patent Application Publication
(10) Pub. No.: US 2024/0201001 A1
(43) Pub. Date: Jun. 20, 2024

(54) INTEGRATED MACHINE LEARNING PLATFORM TO CAPTURE MULTIPHASE VIRTUAL FLOW RATES AND DIAGNOSTIC MEASURES

(71) Applicant: Saudi Arabian Oil Company, Dhahran (SA)

(72) Inventors: Mohammed Elmetwally Gomaa, Dhahran (SA); Mohammad Saeed Al Kadem, Dhahran (SA)

(73) Assignee: SAUDI ARABIAN OIL COMPANY, Dhahran (SA)

(21) Appl. No.: 18/067,457

(22) Filed: Dec. 16, 2022

(51) Int. Cl. G01F 25/10; E21B 49/08; G01F 1/74

(52) U.S. Cl. CPC G01F 25/10; E21B 49/087; G01F 1/74

(57) ABSTRACT

A method for determining phase flow rates of a multiphase fluid flowing in a pipeline of a well. The method includes receiving multiphase flow meter (MPFM) diagnostic inputs and a first phase flow rates measurement from a MPFM disposed on the pipeline. The method further includes receiving virtual flow meter (VFM) inputs from a plurality of field devices disposed on the pipeline, and determining, with a first model, a state of the MPFM. The method further includes determining, with a second model, a second phase flow rates measurement. The method further includes setting a determined phase flow rates measurement to the first phase flow rates measurement if the state of the MPFM is determined not to be in fault, otherwise, setting the determined phase flow rates measurement to the second phase flow rates measurement. The method further includes adjusting one or more field devices in the plurality of field devices.

### BACKGROUND

As oil, gas, and water are produced from a well, they typically flow as a non-homogeneous mixture of phases through a pipeline from the wellhead to a separator. A multiphase flow meter (MPFM) is a device that may be installed on a pipeline to measure the rate at which each phase (oil, gas, water) is flowing. MPFM data are essential for reservoir monitoring and production optimization. Often, MPFM data is processed using vendor-provided software. In instances where more than one MPFM is used, for example, on an oil and gas field consisting of multiple wells, the MPFMs may come from different vendors. In such a case, MPFM data cannot be analyzed across the oil and gas field in a unified manner. Further, MPFMs may malfunction. When an MPFM malfunctions, multiphase flow rate measurements are unavailable to an operator or well and field analysis system.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for determining phase flow rates of a multiphase fluid flowing in a pipeline of a well. The method includes receiving multiphase flow meter (MPFM) diagnostic inputs from a MPFM disposed on the pipeline and receiving a first phase flow rates measurement from the MPFM. The method further includes receiving virtual flow meter (VFM) inputs from a plurality of field devices disposed on the pipeline, and determining, with a first model, a state of the MPFM, wherein the first model processes the MPFM diagnostic inputs. The method further includes determining, with a second model, a second phase flow rates measurement, wherein the second model processes the VFM inputs and setting a determined phase flow rates measurement to the first phase flow rates measurement if the state of the MPFM is determined not to be in fault, otherwise, setting the determined phase flow rates measurement to the second phase flow rates measurement. The method further includes adjusting one or more field devices in the plurality of field devices to optimize production of the well based on the determined phase flow rates measurement.

Embodiments disclosed herein generally relate to a comprehensive flow meter system. The comprehensive flow meter system includes a plurality of field devices disposed on a pipeline of a well, where a multiphase fluid flows through the pipeline. The comprehensive flow meter system further includes a multiphase flow meter (MPFM) disposed on the pipeline, where the MPFM produces a first phase flow rates measurement. The comprehensive flow meter system further includes a MPFM diagnostic tool. The MPFM diagnostic tool includes a first model, wherein the first model is configured to process MPFM diagnostic inputs from the MPFM and determine a state of the MPFM. The MPFM diagnostic tool further includes an alarm generator and a maintenance recommender. The comprehensive flow meter system further includes a virtual flow meter (VFM). The VFM includes a second model, where the second model is configured to process field data from the plurality of field devices and determine a second phase flow rates measurement. The VFM further includes a computer composed of one or more computer processors and a non-transitory computer-readable medium with instructions stored thereon. The instructions, when executed by the one or more computer processors, causing the computer to perform: receiving MPFM diagnostic inputs from the MPFM; receiving the first phase flow rates measurement from the MPFM; receiving the field data from the plurality of field devices; determining, with the first model, the state of the MPFM; determining, with the second model, the second phase flow rates measurement; wherein, if the state of the MPFM is determined not to be in fault, returning the first phase flow rates measurement as a determined phase flow rates measurement for the multiphase fluid, otherwise returning the second phase flow rates measurement as the determined phase flow rates measurement for the multiphase fluid; and adjusting one or more field devices in the plurality of field devices to optimize production of the well based on the determined phase flow rates measurement.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 depicts a pipeline, in accordance with one or more embodiments.

FIG. 2 depicts a multiphase fluid flowing in a pipe, in accordance with one or more embodiments.

FIG. 3 depicts a multiphase flow meter, in accordance with one or more embodiments.

FIG. 4 depicts a comprehensive flow meter system, in accordance with one or more embodiments.

FIG. 5 depicts a neural network, in accordance with one or more embodiments.

FIG. 6 depicts a flowchart, in accordance with one or more embodiments.

FIG. 7 depicts a flowchart, in accordance with one or more embodiments.

FIG. 8 depicts a model, in accordance with one or more embodiments.

FIG. 9 depicts a model, in accordance with one or more embodiments.

FIG. 10 depicts a model, in accordance with one or more embodiments.

FIG. 11 depicts a flowchart, in accordance with one or more embodiments.

FIG. 12 depicts a flowchart, in accordance with one or more embodiments.

FIG. 13 depicts a computing system, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “acoustic signal” includes reference to one or more of such acoustic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

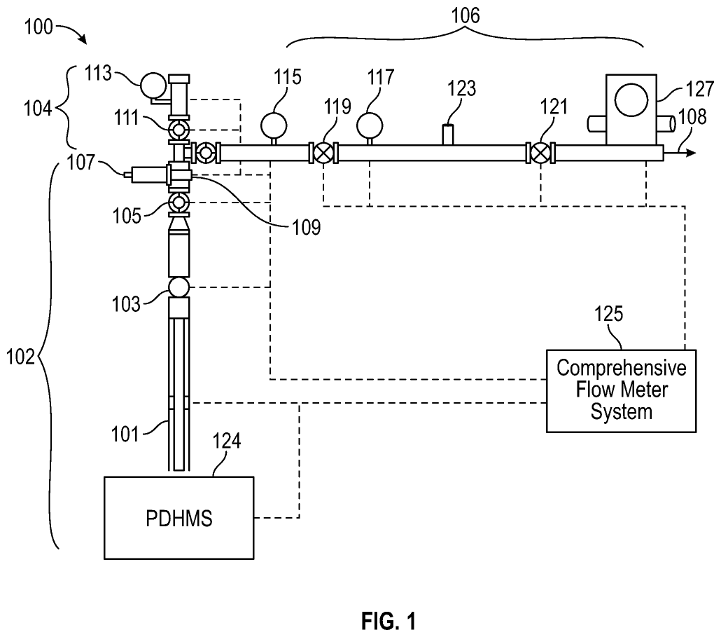

In the following description of FIGS. 1-13, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein relate to a vendor-invariant multiphase flow meter (MPFM) diagnostics system equipped with virtual flow meters (VFMs), hereinafter referred to as a comprehensive flow meter system. An oil and gas field may consist of one or more wells each outfitted with one or more MPFMs. The MPFMs may come from different vendors, each with an associated software to, at the very least, receive flow rate measurements from the MPFM. When a MPFM malfunctions, flow rate measurements at the location of the MPFM are either inaccurate or non-existent.

In accordance with one or more embodiments, the comprehensive flow meter system disclosed herein is configured to receive sensor values and flow rate measurements from one or more MPFMs, regardless of the vendor of the MPFM. Further, the comprehensive flow meter system is configured to detect MPFM malfunctions, identify MPFM issues, and proactively prescribe MPFM preventative maintenance actions. Additionally, the comprehensive flow meter system is configured to receive measurements from field devices of the well and/or oil and gas field. The comprehensive flow meter system is configured to estimate the flow rates of a multiphase fluid using the received field device measurements. Estimating flow rates using field device measurements instead of a MPFM is a process referred to herein as a virtual flow meter (VFM). In other words, in accordance with one or more embodiments, the comprehensive flow meter system can receive flow rate measurements from MPFMs and estimate flow rates using VFMs. By default, the comprehensive flow meter system outputs flow rate measurements acquired using the one or more MPFMs.

The flow rate data determined and output by the comprehensive flow meter system may be received by a system user or other system. For example, the flow rate data may be used by a reservoir simulator or subsurface model to optimize production of hydrocarbons from a well and/or oil and gas field. In the event that the comprehensive flow meter system detects a malfunction in an MPFM, the flow rate provided to a system user, or other system that makes use of flow rate data, is replaced by a VFM estimate determined by the comprehensive flow meter system. As such, accurate multiphase flow rate measurements from a well, or oil and gas field, are provided by the comprehensive flow meter system without interruption. Further, the comprehensive flow meter system allows for proactive and intelligent scheduling of MPFM maintenance activities.

In accordance with one or more embodiments, FIG. 1 depicts a simplified portion of a pipeline (100) of a multilateral well in an oil and gas field. Herein, an oil and gas field is broadly defined to consist of wells which produce at least some oil and/or gas. Hydrocarbon wells typically produce oil, gas, and water in combination. The relative amounts of oil, gas, and water may differ between wells and vary over any one well's lifetime.

For clarity, the pipeline (100) is divided into three sections; namely, a subsurface (102) section, a tree (104) section, and a flowline (106) section. It is emphasized that pipelines (100) and other components of wells and, more generally, oil and gas fields may be configured in a variety of ways. As such, one with ordinary skill in the art will appreciate that the simplified view of FIG. 1 does not impose a limitation on the scope of the present disclosure. As part of the subsurface (102) section, FIG. 1 shows an inflow control valve (ICV) (101). An ICV (101) is an active component usually installed during well completion. The ICV (101) may partially or completely choke flow into a well. Generally, multiple ICVs (101) are installed along the reservoir section of a wellbore. Each ICV (101) is separated from the next by a packer. Each ICV (101) can be adjusted and controlled to alter flow within in the well and, as the reservoir depletes, prevent unwanted fluids from entering the wellbore.

The subsurface (102) section of the pipeline (100) has a subsurface safety valve (SSSV) (103). The SSSV (103) is designed to close and completely stop flow in the event of an emergency. Generally, an SSSV (103) is designed to close on failure. That is, the SSSV (103) requires a signal to stay open and loss of the signal results in the closing of the valve. Also shown as part of the subsurface (102) section is a permanent downhole monitoring system (PDHMS) (124). The PDHMS (124) consists of a plurality of sensors, gauges, and controllers to monitor subsurface flowing and shut-in pressures and temperatures. As such, a PDHMS (124) may indicate, in real-time, the state or operating condition of subsurface equipment and the fluid flow.

Turning to the tree (104) section of FIG. 1 is a master valve (MV) (105), a surface safety valve (SSV) (107), and a wing valve (WV) (109). The MV (105) controls all flow from the wellbore. For safety considerations, a MV (105) is usually considered so important that two master valves (MVs) (second not shown) are used wherein one acts as a backup. Like unto the SSSV (103), the SSV (107) is a valve installed on the upper portions of the wellbore to provide emergency closure and stoppage of flow. Again, SSVs (107) are designed to close on failure. One or more WVs (109) may be located on the side of the tree (104) section, or on temporary surface flow equipment (not shown). WVs (109) may be used to control and isolate production fluids and/or be used for treatment or well-control purposes.

Also shown in FIG. 1 is a control valve (CV) (111) and a pressure gauge (PG) (113). The CV (111) is a valve that controls a process variable, such as pressure, flow, or temperature, by modulating its opening. The PG (113) monitors the fluid pressure at the tree (104) section.

Turning to the flowline (106) section, the flowline (106) transports (108) the fluid from the well to a storage or processing facility (not shown). A choke valve (119) is disposed along the flowline (106). The choke valve (119) is used to control flow rate and reduce pressure for processing the extracted fluid at a downstream processing facility. In particular, effective use of the choke valve (119) prevents damage to downstream equipment and promotes longer periods of production without shut-down or interruptions. The choke valve (119) is bordered by an upstream pressure transducer (115) and a downstream pressure transducer (117) which monitor the pressure of the fluid entering and exiting the choke valve (119), respectively. The flowline (106) shown in FIG. 1 has a block and bleed valve system (121) which acts to isolate or block the flow of fluid such that it does not reach other downstream components. The flowline (106) may also be outfitted with one or more temperature sensors (123).

The various valves, pressure gauges and transducers, and sensors depicted in FIG. 1 may be considered field devices of an oil and gas field. As shown, these field devices may be disposed both above and below the surface of the Earth. These field devices are used to monitor and control components and sub-processes of an oil and gas field. It is emphasized that the oil and gas field devices depicted in FIG. 1 are non-exhaustive. Additional devices, such as electrical submersible pumps (ESPs) (not shown) may be present in an oil and gas field with their associated sensing and control capabilities. For example, an ESP may monitor the temperature and pressure of a fluid local to the ESP and may be controlled through adjustments to ESP speed or frequency.

The field devices may be distributed, local to the sub-processes and associated components, global, connected, etc. The field devices may be of various control types, such as a programmable logic controller (PLC) or a remote terminal unit (RTU). For example, a programmable logic controller (PLC) may control valve states, pipe pressures, warning alarms, and/or pressure releases throughout the oil and gas field. In particular, a programmable logic controller (PLC) may be a ruggedized computer system with functionality to withstand vibrations, extreme temperatures, wet conditions, and/or dusty conditions, for example, around a pipeline (100). With respect to an RTU, an RTU may include hardware and/or software, such as a microprocessor, that connects sensors and/or actuators using network connections to perform various processes in the automation system. As such, a distributed control system may include various autonomous controllers (such as remote terminal units) positioned at different locations throughout the oil and gas field to manage operations and monitor sub-processes. Likewise, a distributed control system may include no single centralized computer for managing control loops and other operations.

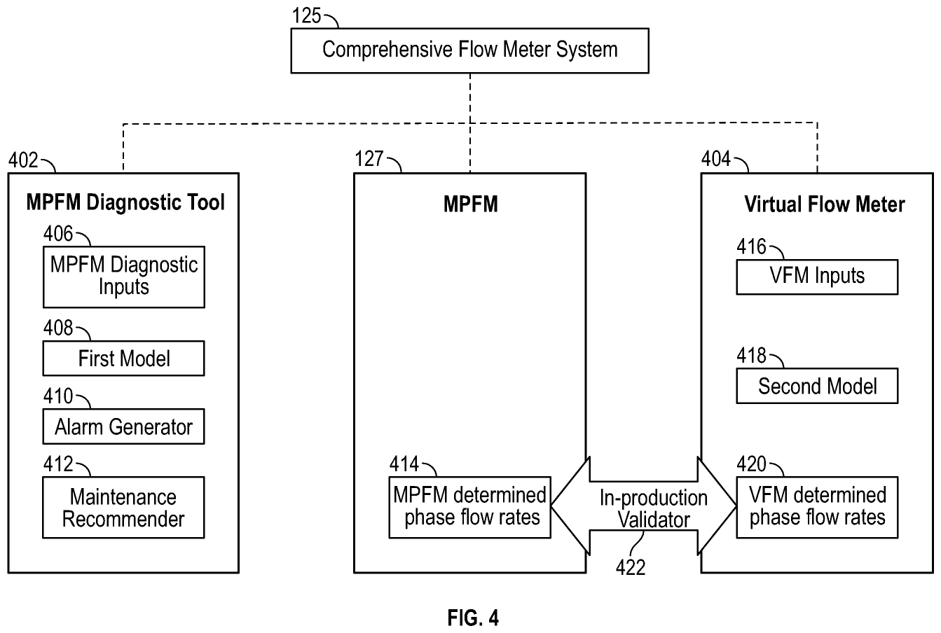

In accordance with one or more embodiments, FIG. 1 depicts the comprehensive flow meter system (125). The comprehensive flow meter system includes functionality for field device monitoring and data collection. In one or more embodiments, the comprehensive flow meter system (125) further includes functionality for issuing field device commands. As will be described in greater detail with reference to FIG. 4, the comprehensive flow meter system (125) includes functionality to output and visualize multiphase flow rate measurements to a control room or operations center, analyze MPFMs for malfunctions, intelligently recommend preventative maintenance activities, provide alerts and/or alarms, and estimate multiphase flow rates from field device data (i.e., a VFM estimate), and continuously provide accurate multiphase flow rate measurements regardless of the state of any MPFM. To emphasize that the comprehensive flow meter system (125) can monitor and, in some embodiments, control the various field devices of a well and/or an oil and gas field, dashed lines connecting various field devices to the comprehensive flow meter system (125) are shown in FIG. 1.

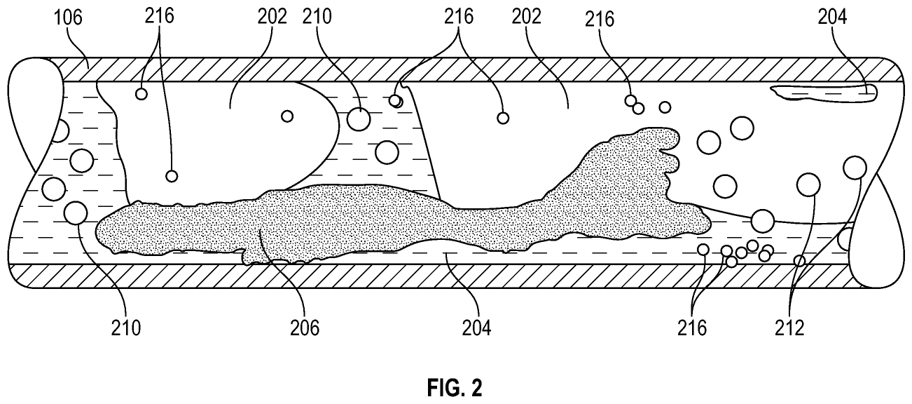

FIG. 2 depicts a simplified view of a cross-section of a flowline (106) carrying a multiphase fluid. As seen, the multiphase fluid may have multiple constituents such as gas (202), water (204), and oil (206). The various constituents of the multi-phase fluid may be distributed within the flowline (106) in a myriad of ways. As a non-limiting example, gas (202) may be enclosed by liquids (water or oil) forming bubbles (210). Or, in contrast, liquid droplets, such as oil droplets (216) and water droplets (212), may be dispersed in the gas (202) to form a mist. In general, the state of the multiphase fluid may be described using broad classifications. That is, the multi-phase fluid may be categorized as “bubbly,” “annular,” “churn,” “mist,” “stratified,” or other designations (flow classes) based on the distribution of the constituents and their relative quantities. The state of the multiphase fluid may be transient such that any assignment of flow class may change with time.

Oil and gas field devices, like those shown in FIG. 1 (and others not shown), monitor and govern the behavior of the components and sub-processes of the well and/or the oil and gas field. Therefore, the productivity of the well and/or the oil and gas field is directly affected, and may be altered by, at least some, of the field devices. Generally, complex interactions between oil and gas field components and sub-processes exist such that configuring field devices for optimal production is a difficult and laborious task. Further, the state and behavior of oil and gas fields is transient over the lifetime of the constituent wells requiring continual changes to the field devices to enhance production.

To inform and optimize the settings of the field devices of a pipeline (100) to maximize hydrocarbon production, it is beneficial, if not critical, to determine the instantaneous state of the multiphase flow. To this end, the pipeline (100) depicted in FIG. 1 is outfitted with a multiphase flow meter (MPFM) (127). A MPFM (127) is a device installed on the flowline (106) to measure the rate at which each phase—oil, gas, water—is flowing. That is, the MPFM (127) may detect the instantaneous amount of gas, oil, and water flowing in the pipeline (100). As such, the MPFM (127) indicates additional quantities such as percent water cut (% WC) and the gas-to-oil ratio (GOR).

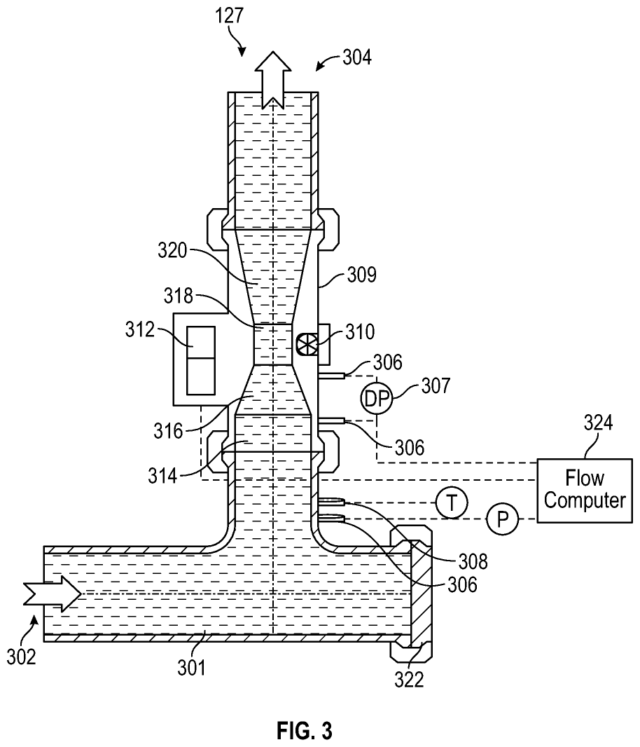

In general, a MPFM (127) cannot directly measure the flow rate of the individual phases in a fluid. Rather, a MPFM (127) is a collection of sensors, transmitters, mechanical devices, flow conduits, and programmed relationships that are used to determine the individual phase flow rates. FIG. 3 depicts a MPFM (127) in accordance with one or more embodiments. A MPFM (127) may be disposed inline with a flowline (106), or proximate to a flowline (106), such that the MPFM (127) can receive the multiphase fluid (301) through a flow inlet (302) and return the fluid through a flow outlet (304). The MPFM (127) of FIG. 3 includes one or more pressure sensors (306) and temperature sensors (308) to measure the pressure (P) and temperature (T), respectively, at various locations within the MPFM (127). The pressure (P) and temperature (T) measurements are used, in part, to determine the thermophysical state and the thermophysical properties of the multiphase fluid (301). For example, the pressure (P) and temperature (T) values may be used with a functional or tabulated equation of state (EoS) to determine other properties of the multiphase fluid (301).

The MPFM (127) of FIG. 3 uses a gamma densitometer (309) to measure the bulk density of the multiphase fluid (301). The gamma densitometer (309) emits a beam of photons from a nuclear source (310). The emitted photons are attenuated by the multiphase fluid (301) and the amount of attenuation is determined using a nuclear detector (312) that measures the number of received photons. The amount of attenuation is greatly affected by the bulk density of the multiphase fluid (301). Further, because gas has a significantly lower density compared to water and oil, the gamma densitometer (309) can be used to accurately determine the liquid (water and oil) and gas fractions of the multiphase fluid (301).

The MPFM (127) depicted in FIG. 3 further includes a Venturi section. The Venturi section is composed of a Venturi inlet (314), a nozzle (316), a throat section (318), and a diffuser (320). The constriction in flow that occurs in the Venturi section acts to increase the bulk flow velocity of the multiphase fluid (301) and is associated with a decrease in pressure (P). The MPFM (127) is configured with pressure sensors (306) to determine the difference in pressure (DP) (307) of the multiphase fluid (301) between the Venturi inlet (314) and the throat section (318). The Venturi section is used to measure mass flow rates.

The MPFM (127) of FIG. 3 further includes a blind tee or static mixer (322). The blind tee (322) serves to condition the flow of the multiphase fluid (301) such that it is homogeneous before entering the main body of the MPFM (127). The blind tee (322) is disposed immediately upstream of the Venturi section and creates a mixing effect that stabilizes intermittent flow regimes commonly encountered in multiphase fluids (301) associated with wells. The blind tee (322) also mitigates any flow interaction with field devices located upstream from the MPFM (127) such as the choke valve (119).

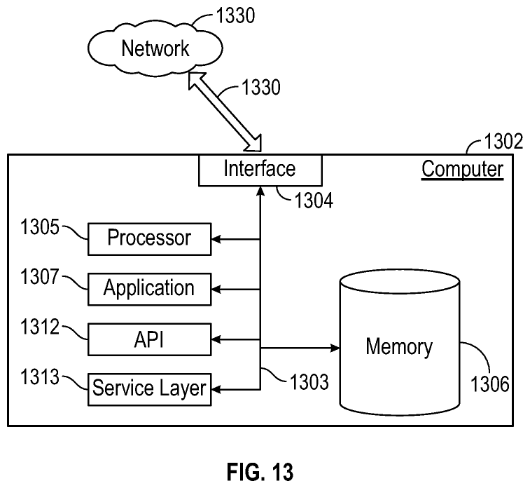

The MPFM (127) is outfitted with a flow computer (324). The flow computer (324) receives the readings from the sensors (e.g., temperature sensor (308), pressure sensor (306)) of the MPFM (127). That is, the flow computer (324) acts, in part, as a data acquisition unit. Upon collecting the sensor data, the flow computer (324) calculates the individual flow rates of the oil, gas, and water present in the multiphase fluid (301). The flow computer (324) can transmit the computed flow rates and acquired sensor data to an external system such as the comprehensive flow meter system (125). Generally, the flow computer (324) makes use of programmed relationships to determine the phase flow rates from the acquired sensor data. The programmed relationships may include or make use of analytical or tabulated equations of state (EoS) data, phenomenological models, physics-based relationships, bounded correlations, and governing equations (e.g., conservation of mass). In one or more embodiments, the flow computer (324) may be a computer system as depicted in FIG. 13, which will be described in greater detail later in the disclosure.

It is emphasized that the MPFM (127) depicted in FIG. 3 is provided only as an example. In practice, many different types of MPFMs (127) exist. MPFMs (127) may differ in the types of sensors used, the data they collect, and the programmed relationships used to convert the measured flow properties to phase flow rates. For example, in some instances, a MPFM (127) may further be outfitted with a capacitance sensor to determine the fraction of oil, water, and gas in the multiphase fluid (301). In other instances, a MPFM (127) may use any combination of a X-ray source and detector, electrodes, strain gauges, magnetic resonance, and optical sensors and computer vision-based algorithms. One with ordinary skill in the art will recognize that the above description of a MPFM (127) or the components that may make up a MPFM (127) are non-exhaustive and should not be construed to impose a limitation on the instant disclosure. In general, the comprehensive flow meter system (125) disclosed herein can work with any type of MPFM (127).

The main elements of the comprehensive flow meter system (125) are shown in FIG. 4. It is noted that the elements shown in FIG. 4 are abstractions and that, in practice, an element may not be unique or independent from other elements of the system. Further, the functionality of one or more elements may be shared between any number of elements. As depicted in FIG. 4, the comprehensive flow meter system (125) is connected to at least one MPFM (127). The MPFM (127) provides phase flow rates, or the individual flow rates of oil, water, and gas, flowing through a pipeline (100) at the location of the MPFM (127). The provided phase flowrates are referred to herein as the MPFM determined phase flow rates (414). For clarity, the comprehensive flow meter system (125) will be discussed as connected to a single MPFM (127), however, one skilled in the art will recognize that the comprehensive flow meter system (125) can be used with any number of MPFMs (127). Further, the comprehensive flow meter system (125) can work with any type of MPFM (127) regardless of its manufacturer or vendor.

The comprehensive flow meter system (125) further includes a MPFM diagnostic tool (402). The MPFM diagnostic tool (402) is configured to receive MPFM diagnostic inputs (406). The MPFM diagnostic inputs (406) consist of the measurements and sensory data acquired by the MPFM (127). For example, the MPFM diagnostic inputs (406) may include the values of a temperature sensor (308), pressure sensors (306), and the nuclear detector (312). MPFM diagnostic inputs (406) may further include the operating temperature of the flow computer (324) and voltages supplied to any of the sensors in the MPFM (127). In general, the MPFM diagnostic inputs (406) comprise any measured quantity or available data from, and associated with, the MPFM (127).

The MPFM diagnostics tool (402) further includes a first model (408). The first model (408) is a machine-learned model. A greater description of machine-learned models is provided later in the instant disclosure. For now, it is sufficient to say that the first model (408) is trained and configured to process the MPFM diagnostic inputs (406) and identify issues, or potential issues, in the MPFM (127). For example, in one or more embodiments, the first model (408) may be configured to output the state or condition of the MPFM (127) from a set of prespecified states, such as “normal,” “malfunction,” and “suspicious.” In other embodiments, the first model (408) may detect anomalies in the MPFM diagnostic inputs, such as abnormal temperature readings. Associated with the output of the first model (408), the MPFM diagnostic tool (402) further includes an alarm generator (410) and a maintenance recommender (412). The alarm generator (410) is a collection of rules that, based on the output of the first model (408), can trigger and transmit an alarm to a user or another system. Each alarm has a priority level. For example, in one or more embodiments, alarms may be categorized has “high,” “medium,” and “low” priority.

Similarly, based on, in part, the output of the first model (408), the maintenance recommender (412) produces a maintenance recommendation. In accordance with one or more embodiments, the supplied maintenance recommendation indicates which component of the MPFM (127) is malfunctioning greatly reducing the time required for a maintainer to identify and correct the issue. In one or more embodiments, the maintenance recommender (412) can recommend service to a MPFM (127) or component of an MPFM (127) before a malfunction occurs. For example, the maintenance recommender (412), in coordination with the first model (408), may detect an increase in the frequency of anomalous sensor readings (e.g., temperature sensor (308)) and recommend servicing or replacing the associated sensor in a MPFM (127). Or, as another example, the maintenance recommender (412) may detect non-stationary and increasing variance in the recorded values of a sensor or a divergence between two or more sensors with identified correlations.

A major advantage of the maintenance recommender (412), which uses in part the output of the first model (408), is that it can identify potential issues or degrading equipment and provide proactive and preventative maintenance recommendations that are informed by the current condition and history of a MPFM (127) as opposed to a time-based, unfocused maintenance approach. Currently, MPFMs (127) are repaired reactively and maintained according to a predefined schedule. For example, a faulty MPFM (127) may transmit inaccurate phase flow rates that may result in temporarily taking well and/or oil and gas field analyses and optimization efforts, which rely on phase flow rates, offline. In order to restore high-priority systems that are dependent on phase flow rates, a maintainer may be immediately dispatched to repair or replace the MPFM (127). Such reactive service visits are costly in terms of personnel time and resource allocation. Further, scheduled preventative maintenance, while helpful in mitigating downtime incidents, is diluted and inefficient, as many MPFMs (127) will not require extensive, or any, servicing to remain operational and accurate. Thus, because the maintenance recommender (412) can identify potential issues and degrading equipment, the efforts of maintenance personnel can be focused on emerging problems and dynamically scheduled according to need. This knowledge enables the optimization of maintenance visits, especially to oil and gas fields that reside offshore, which, in turn, reduces the maintainer risk associated with the visits while minimizing equipment downtime.

Continuing with FIG. 4, the comprehensive flow meter system (125) includes a virtual flow meter (VFM) (404). In accordance with one or more embodiments, the comprehensive flow meter system (125) provides a VFM (404) for each MPFM (127) encompassed by the comprehensive flow meter system (125). Again, for clarity, the VFM (404) will be discussed herein in reference to a single MPFM (127). In general, a VFM (404) operates by using one or more numerical models to estimate the individual phase flow rates of a multiphase fluid using readily available field device data. In accordance with one or more embodiments, the VFM (404) receives VFM inputs (416) and processes the VFM inputs (416) with a second model (418) to determine the individual phase flow rates. For clarity, when the phase flow rates are estimated using the VFM (404), they are referred to as VFM determined phase flow rates (420). In one or more embodiments, the second model (418) consists of at least one machine-learned model.

In one or more embodiments, the comprehensive flow meter system (125) further includes an in-production validator (422). When the VFM (404) is operating on a producing well, or with an oil and gas field, outside of testing or training procedures, the VFM is said to be operating “in-production.” While the MPFM diagnostic tool (402) does not detect any issues or malfunctions with the MPFM (127), the VFM determined phase flow rates (420) may be compared with the MPFM determined phase flow rates (414) using the in-production validator (422). The in-production validator (422) may recommend adjustments to the second model (418) such that the VFM determined phase flow rates (420) more closely align with the MPFM determined phase flow rates (414).

As discussed, in one or more embodiments, the first model (408) and the second model (418) are machine-learned models, or are, at least in part, composed of machine-learned models. Machine learning, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein, however, one skilled in the art will recognize that the concepts and methods detailed hereafter are not limited by this choice of nomenclature.

Machine-learned model types may include, but are not limited to, neural networks, random forests, generalized linear models, and Bayesian regression. Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameter surrounding a model is referred to as selecting the model “architecture”. Consequently, in many circumstances, a machine-learned model may be specified by indicating its type and associated hyperparameters.

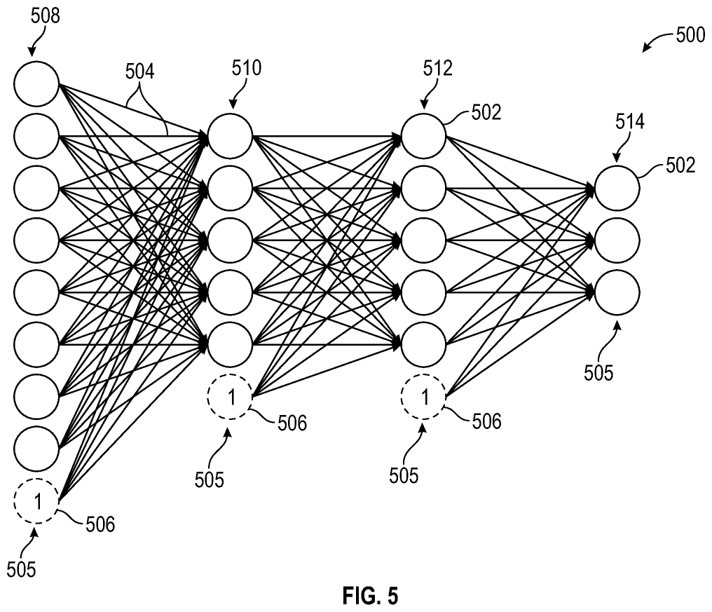

In one or more embodiments, the machine-learned model type of the first model (408) and/or the second model (418) is a neural network. A diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer”. Any intermediate layer (510, 512) is usually described as a “hidden layer”. A neural network (500) may have zero or more hidden layers (510, 512) and a neural network (500) with at least one hidden layer (510, 512) may be described as a “deep” neural network or as a “deep learning method.” In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters”. While training a neural network (500), numerical values are assigned to each edge (504). Additionally, every node (502) is associated with a numerical variable and an activation function. Activation functions are not limited to any functional class, but traditionally follow the form

A=ƒ(Σ_{i∈(incoming)}[(node value)ᵢ(edge value)ᵢ]).

where i is an index that spans the set of “incoming” nodes (502) and edges (504) and ƒ is a user-defined function. Incoming nodes (502) are those that, when viewed as a graph (as in FIG. 5), have directed arrows that point to the node (502) where the numerical value is being computed. Some functions for ƒ may include the linear function ƒ (x)=x, sigmoid function

$$f ( x ) = \frac{1}{1 + {e}^{- x}} ,$$

and rectified linear unit function ƒ(x)=max(0, x), however, many additional functions are commonly employed. Every node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (505), displayed in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

As noted, the training procedure for the neural network (500) comprises assigning values to the edges (504). To begin training the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. Generally, a training dataset is provided the neural network for training. The training dataset is composed of inputs and associated target(s), where the target(s) represent the “ground truth”, or the otherwise desired output. The neural network (500) output is compared to the associated input data target(s). The comparison of the neural network (500) output to the target(s) is typically performed by a so-called “loss function”; although other names for this comparison function such as “error function” and “cost function” are commonly employed. Many types of loss functions are available, such as the mean-squared-error function, however, the general characteristic of a loss function is that the loss function provides a numerical evaluation of the similarity between the neural network (500) output and the associated target(s). The loss function may also be constructed to impose additional constraints on the values assumed by the edges (504), for example, by adding a penalty term, which may be physics-based, or a regularization term. Generally, the goal of a training procedure is to alter the edge (504) values to promote similarity between the neural network (500) output and associated target(s) over the data set. Thus, the loss function is used to guide changes made to the edge (504) values, typically through a process called “backpropagation”.

While a full review of the backpropagation process exceeds the scope of this disclosure, a brief summary is provided. Backpropagation consists of computing the gradient of the loss function over the edge (504) values. The gradient indicates the direction of change in the edge (504) values that results in the greatest change to the loss function. Because the gradient is local to the current edge (504) values, the edge (504) values are typically updated by a “step” in the direction indicated by the gradient. The step size is often referred to as the “learning rate” and need not remain fixed during the training process. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the neural network (500) will likely produce different outputs. Thus, the procedure of propagating at least one input through the neural network (500), comparing the neural network (500) output with the associated target(s) with a loss function, computing the gradient of the loss function with respect to the edge (504) values, and updating the edge (504) values with a step guided by the gradient, is repeated until a termination criterion is reached. Common termination criteria are: reaching a fixed number of edge (504) updates, otherwise known as an iteration counter; a diminishing learning rate; noting no appreciable change in the loss function between iterations; reaching a specified performance metric as evaluated on the data or a separate hold-out dataset. Once the termination criterion is satisfied, and the edge (504) values are no longer intended to be altered, the neural network (500) is said to be “trained.”

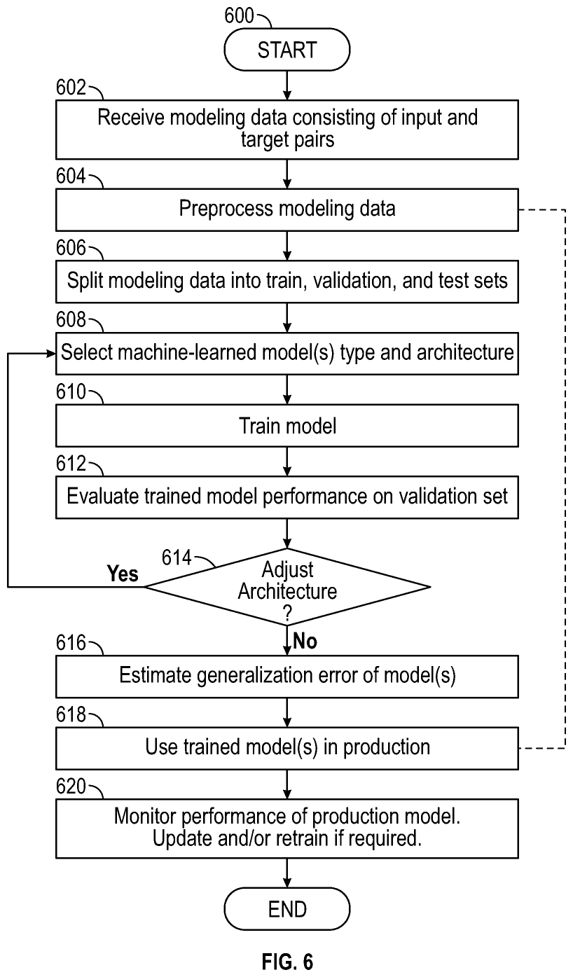

FIG. 6 depicts the general process of selecting and training a machine-learned model, in accordance with one or more embodiments. The process shown in FIG. 6 may be applied to train the first model (408) and/or the second model (418).

To start, as shown in Block 602, modelling data is received. The modelling data consists of input and target pairs. For example, to train the first model (408), an input and target pair may consist of the MPFM diagnostic inputs (406) and the associated state or condition of the MPFM (127) at the time when the MPFM diagnostic inputs (406) were collected. In accordance with one or more embodiments, the MPFM diagnostic inputs (406) include gamma counts, supplied voltage, Venturi differential pressure, and the flow computer (324) temperature of the MPFM (127). In one or more embodiments, the state or condition of the MPFM (127) is determined manually by an operator.

Likewise, to train the second model (418), the modelling data consists of pairs of VFM inputs (416) and the associated phase flow rates. In accordance with one or more embodiments, the VFM inputs include, but are not limited to: wellhead pressure, upstream wellhead temperature, downstream wellhead pressure, Venturi differential pressure, choke valve position, ESP frequency, and ESP motor current. The VFM inputs are collected using field devices appropriately disposed on the pipeline (100).

In other words, in general, the modelling data consists of the expected input and desired output for the machine-learned model. In accordance with one or more embodiments, the modelling data is acquired from one or more existing wells or from previously collected historical well data. Returning to FIG. 6, in one or more embodiments, the modelling data is preprocessed as depicted by Block 604. Preprocessing, at a minimum, comprises altering the modelling data so that it is suitable for use with machine-learned models. For example, numericalizing categorical data or removing data entries with missing values. Other typical preprocessing methods are normalization and imputation. Information surrounding the preprocessing steps is saved for potential later use. For example, if normalization is performed then a computed mean vector and variance vector are retained. This allows future modelling data to be preprocessed identically. Values computed and retained during preprocessing are referred to herein as preprocessing parameters. One with ordinary skill in the art will recognize that a myriad of preprocessing methods beyond numericalization, removal of modelling data entries with missing values, normalization, and imputation exist. Descriptions of a select few preprocessing methods herein do not impose a limitation on the preprocessing steps encompassed by this disclosure.

As shown in Block 606, the modelling data is split into training, validation, and test sets. In some embodiments, the validation and test set may be the same such that the data is effectively only split into two distinct sets. In some instances, Block 606 may be performed before Block 604. In this case, it is common to determine the preprocessing parameters, if any, using the training set and then to apply these parameters to the validation and test sets.

In Block 608, one or more machine-learned model types and associated architectures are selected. For example, in one or more embodiments, the first model (408) and/or the second model (418) are composed of more than one machine-learned models. In this case, each of the one or more machine-learned models are selected. For each machine-learned model, once the machine-learned model type and hyperparameters have been selected, the machine-learned model is trained using the training set of the modelling data according to Block 610. Common training techniques, such as early stopping, adaptive or scheduled learning rates, and cross-validation may be used during training without departing from the scope of this disclosure.

During training, or once trained, the performance of the trained machine-learned model is evaluated using the validation set as depicted in Block 612. Recall, that in some instances, the validation set and test set are the same. Generally, performance is measured using a function which compares the predictions of the trained machine-learned model to the given targets. A commonly used comparison function is the mean-squared-error function, which quantifies the difference between the predicted value and the actual value when the predicted value is continuous, however, one with ordinary skill in the art will appreciate that many more comparison functions exist and may be used without limiting the scope of the present disclosure.

Block 614 represents a decision: if the trained machine-learned model performance, as measured by a comparison function on the validation set (Block 612), is not suitable, the machine-learned model architecture may be altered (i.e., return to Block 608) and the training process is repeated. There are many mays to alter the machine-learned model architecture in search of suitable trained machine-learned model performance. These include, but are not limited to: selecting a new architecture from a previously defined set; randomly perturbing or randomly selecting new hyperparameters; using a grid search over the available hyperparameters; and intelligently altering hyperparameters based on the observed performance of previous models (e.g., a Bayesian hyperparameter search). Once suitable performance is achieved, the training procedure is complete and the generalization error of the trained machine-learned model(s) is estimated according to Block 616.

Generalization error is an indication of the trained machine-learned model's performance on new, or un-seen data. Typically, the generalization error is estimated using the comparison function, as previously described, using the modelling data that was partitioned into the test set.

As depicted in Block 618, the trained machine-learned model(s) is used “in production”—which means the trained machine-learned model(s) is used to process a received input without having a paired target for comparison. It is emphasized that the inputs received in the production setting, as well as for the validation and test sets, are preprocessed identically to the manner defined in Block 604 as denoted by the connection (622), represented as a dashed line in FIG. 6, between Blocks 618 and 604.

In accordance with one or more embodiments, the performance of the trained machine-learned model(s) is continuously monitored in the production setting. As an example, when the MPFM (127) is determined to be healthy by the first model (408), the VFM determined flow rates (420), which are the output of the second model (418) can be compared to the MPFM determined phase flow rates (414) using the in-production validator (422). That is, the MPFM determined phase flow rates (414) can be compared to the VFM determined phase flow rates (420) from the second model (418) using a comparison function to monitor performance. If model performance is suspected to be degrading, as observed through in-production performance metrics, the model may be updated. An update may include retraining the model, by reverting to Block 608, with the newly acquired modelling data from the in-production recorded values appended to the training data. An update may also include returning to Block 404 to recalculate any preprocessing parameters, again, after appending the newly acquired modelling data to the existing modelling data.

While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

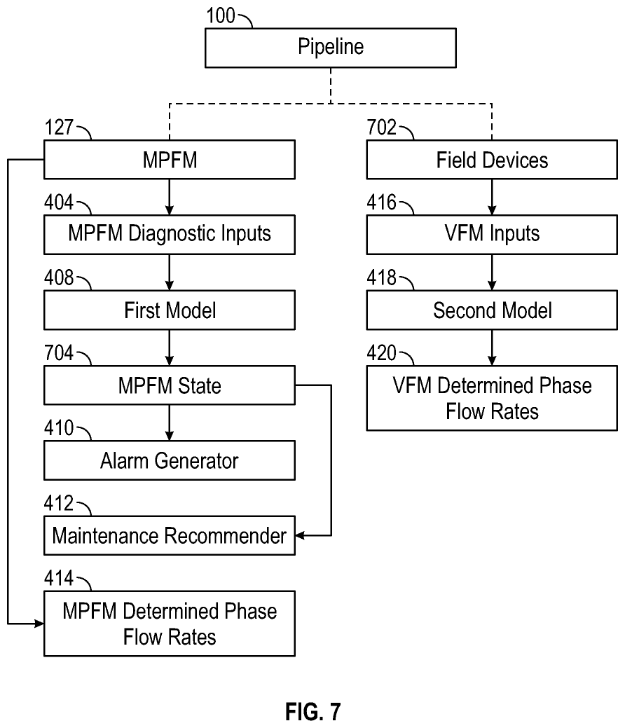

FIG. 7 depicts the flow of data for the comprehensive flow meter system (125). In accordance with one or more embodiments, a pipeline (100) is outfitted with a MPFM (127) and various field devices (702). The MPFM (127) provides measurements for the individual phase flow rates of a multiphase fluid (301) flowing in the pipeline (100) (i.e., MPFM determined phase flow rates (414)). In addition to providing MPFM determined phase flow rates (414), the MPFM (127) transmits sensory data and/or measurements from its internal components. The transmitted MPFM (127) sensory data and/or measurements from its internal components are collectively known as the MPFM diagnostic inputs (404). The MPFM diagnostic inputs (404) are processed by the first model (408) to determine a MPFM state (704). The MPFM state (704) indicates the condition of the MPFM (127) including the identification of potential issues. The MPFM state (704) is used, at least in part, with the alarm generator (410) and the maintenance recommender (412). That is, depending on the MPFM state (704), the comprehensive flow meter system (125) can make various maintenance recommendations and raise various alarms. Data received from the field devices (702) is collected as VFM inputs (416). The VFM inputs (416) are processed by the second model (418) which returns VFM determined phase flow rates (420).

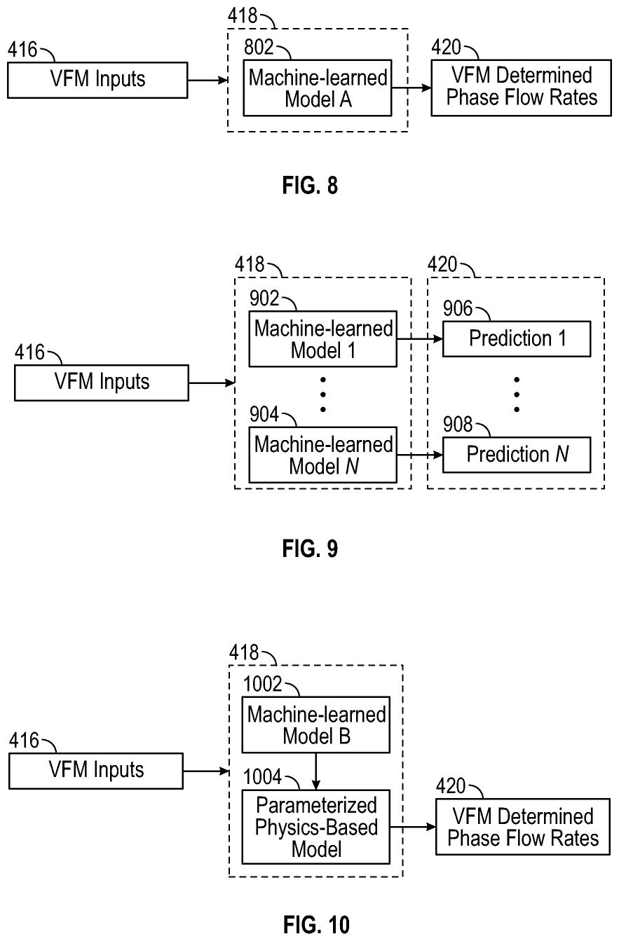

In accordance with one or more embodiments, and as depicted in FIG. 8, the second model (418) is composed of a single machine-learned model labelled herein as machine-learned model A (802). In this embodiment, machine-learned model A (802) is trained according to the procedures previously described and depicted in FIG. 6. In one or more embodiments, the modelling data is acquired from existing pipelines (100) outfitted with functional MPFMs (127). That is, when training machine-learned model A (802), the modelling data is a historical record of field device data and MPFM determined phase flow rates (414) from one or more wells. Once trained, machine-learned model A (802) can receive VFM inputs (416) (i.e., field device data) and return VFM determined phase flow rates (420). In one or more embodiments, machine-learned model A (802) is a physics informed machine-learned model. In this case, machine-learned model A (802) is trained using a regularization term that enforces one or more physical constraints and/or penalizes a departure from one or more physical constraints.

FIG. 9 depicts an alternative embodiment of the second model (418). As seen in FIG. 9, the second model (418) is composed of N machine-learned models where N is an integer greater than or equal to two. In this embodiment, the machine-learned models are labelled machine-learned model 1 (902), machine-learned model 2 (not shown), and so on and so forth, until machine-learned model N. The machine-learned models may differ in their type and/or architecture. For example, the second model (418) may be composed of a neural network (500), a random forest, and a generalized linear model (i.e., machine-learned models 1, 2, and 3, respectively). Each of the machine-learned models receives the VFM inputs (416) and returns a phase flow rates prediction. The phase flow rates predictions are similarly labelled prediction 1 (906), prediction 2 (not shown), and so on and so forth, until prediction N (908). The collection of predictions make up the VFM determined phase flow rates (420). In one or more embodiments, the predictions are averaged together to form a single estimate for the VFM determined phase flow rates (420). In other embodiments, each prediction (1 through N) is continuously monitored and compared to the MPFM determined phase flow rates (414) when the MPFM determined phase flow rates (414) are determined to be accurate. In this case, only the model that has the greatest accuracy compared to the MPFM determined phase flow rates (414) is returned as the VFM determined phase flow rates (420). Thus, when the MPFM determined phase flow rates (414) are determined to be inaccurate due to, for example, a fault in the MPFM (127), only the machine-learned model with the greatest historical in-production accuracy is used to determine the VFM determined phase flow rates (420).

FIG. 10 depicts the second model (418) in accordance with one or more embodiments. As shown in FIG. 10, the second model (418) is composed of a machine-learned model, machine-learned model B (1002), and a parameterized physics-based model (1004). The parameterized physics-based model (1004) can be tuned according to a set of model parameters. In this embodiment, machine-learned model B (1002) receives the VFM inputs (416) and outputs the model parameters for the parameterized physics-based model (1004). Once parameterized, the parameterized physics-based model (1004) receives the VFM inputs (416), at least in part, and outputs the VFM determined phase flow rates (420).

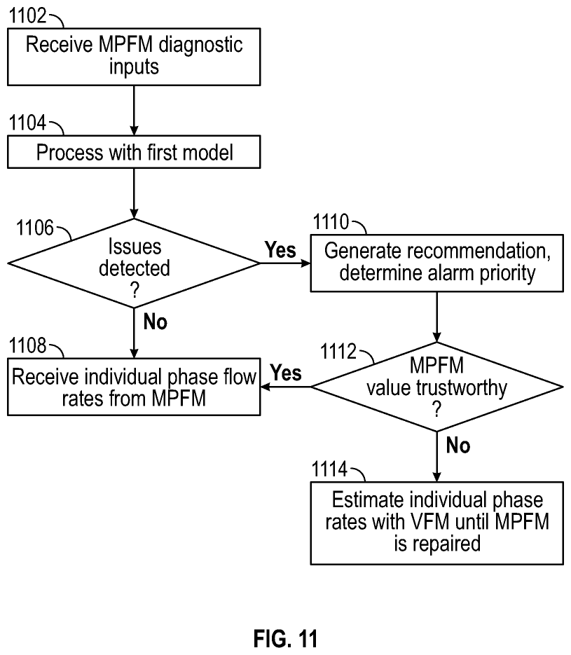

Given that the comprehensive flow meter system (125) can, at any given time, output MPFM determined phase flow rates (414) and VFM determined phase flow rates (420) to a user and/or an external system, FIG. 11 depicts a flowchart demonstrating which phase flow rate should be used. As shown in Block 1102, the comprehensive flow meter system (125) receives MPFM diagnostic inputs from the MPFM (127). The MPFM diagnostic inputs (406) are processed with the first model (1104) as shown in Block 1104. The first model (408) determines and identifies issues (e.g., malfunctions) and potential issues (e.g., infrequent anomalous behavior) with the MPFM (127) associated with the MPFM diagnostic inputs (406). In Block 1106, if no issues (or potential issues) are detected, then the comprehensive flow meter system (125) uses the received the individual phase flow rates directly from the MPFM (127). If, however, in Block 1106, any issues or potential issues are detected, a recommendation is generated by the maintenance recommender (412) and one or more alarms are raised according to a determined alarm priority by the alarm generator (410) as shown in Block 1110. Further, in Block 1112, based on the detected issue or potential issue, the trustworthiness of the MPFM (127) is determined. For example, if the detected issue indicates that the MPFM (127) is malfunctioning (i.e., the MPFM is in a state of fault) then the MPFM determined phase flow rates (414) are not considered trustworthy. In this case, the individual phase flow rates are estimated using the VFM (404) (i.e., the second model (418)) until the MPFM (127) is repaired, replaced, or otherwise made functional and accurate as depicted in Block 1114. If, however, in Block 1112, the MPFM (1112), despite the detected issue, is thought to be trustworthy, then the comprehensive flow meter system (1108) continues to use the MPFM determined phase flow rates (414). For example, the MPFM diagnostic tool (402) may indicate that the MPFM (127) is degrading and should undergo preventative maintenance in the near future but is currently not in error.

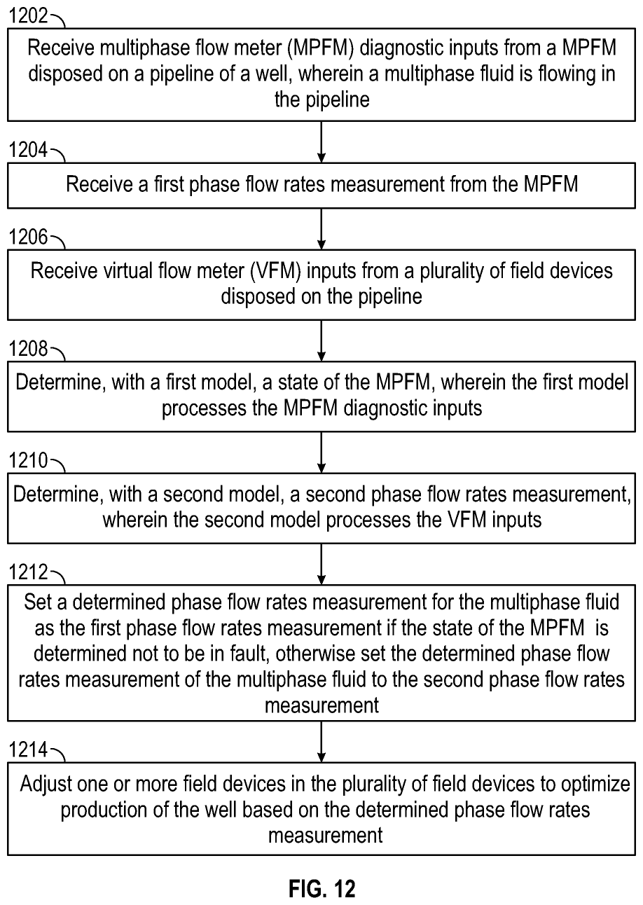

FIG. 12 depicts a flowchart outlining usage of the comprehensive flow meter system (125), in accordance with one or more embodiments. In Block 1202, the comprehensive flow meter system (125) receives MPFM diagnostic inputs (406) from an MPFM (127) disposed on a pipeline (100) of a well. A multiphase fluid composed of oil, water, and gas is flowing through the pipeline (100). The MPFM diagnostic inputs (404) include measurements from the internal components of the MPFM (127). For example, in one or more embodiments, the MPFM diagnostic inputs (404) include gamma counts, supplied voltage, Venturi differential pressure (307), and the flow computer (324) temperature.

In Block 1204, a first phase flow rates measurement is received from the MPFM (127). The first phase flow rates measurement is the MPFM determined phase flow rates (414) for the individual phases of oil, water, and gas, flowing in the pipeline (100). In Block 1206, virtual flow meter (VFM) inputs (416) are received from a plurality of field devices disposed on the pipeline (100). In one or more embodiments, the VFM inputs (416) include the wellhead pressure, the upstream wellhead temperature, the downstream wellhead pressure, the Venturi differential pressure, the choke valve position, and the electrical submersible pump (ESP) frequency and ESP motor current.

In Block 1208, the state of the MPFM (127) is determined using the first model (408). The first model (408) is composed of one or more machine-learned models and is configured to process the MPFM diagnostic inputs (404) and output a state or condition of the MPFM (127) (i.e., MPFM state (704)). In one or more embodiments, the first model (408) identifies issues or potential issues surrounding the MPFM (127). Further, the state of the MPFM (127) indicates, at a minimum, if the MPFM (127) is in a state of fault (i.e., malfunctioning, MPFM determined phase flow rates are not trustworthy).

In Block 1210, the second model (418) is used to process the VFM inputs (416) and output a second phase flow rates measurement. The second phase flow rates measurement is the VFM determined phase flow rates (420). The second model (418) is composed of at least one machine-learned model. In one or more embodiments, the second model (418) is composed of multiple, independent, machine-learned models. In this case, in one or more embodiments, the predicted phase flow rates of the multiple machine-learned models of the second model (418) are each compared to the MPFM determined phase flow rates (414) when the state of the MPFM (127) is not in fault and the MPFM determined phase flow rates (414) are considered trustworthy. The comparison of the predicted phase flow rates and the MPFM determined phase flow rates (414) can be done using the in-production validator (422).

In Block 1212, based on the state of the MPFM (127) as determined by the first model (408), the comprehensive flow meter system (125) determines which of the phase flow rates measurements should be used. If the state of the MPFM (127) is not in fault, then the comprehensive flow meter system (125) sets the determined phase flow rates measurement to the first phase flow rates measurements (i.e., the MPFM determined phase flow rates (414)). If, however, the MPFM (127) is determined to be in a state of fault, then the determined phase flow rates measurement is set to the second phase flow rates measurement (i.e., VFM determined phase flow rates (420)). In one or more embodiments, when the second model (418) is composed of more than one machine-learned models and the MPFM (127) is determined to be in a state of fault, the machine-learned model that had the closest approximation to the MPFM determined phase flow rates (414) before the MPFM (127) was determined to be in a state of fault, as determined by the in-production validator (420), is used as the VFM determined phase flow rates (420).

In Block 1214, based on the determined phase flow rates, the comprehensive flow meter system (125) may adjust the settings of one or more field devices to optimize the production of the well. While the flowchart of FIG. 12 references a single MPFM (127) disposed on a pipeline, the comprehensive flow meter system (125) is not limited to a single MPFM (127). In general, the comprehensive flow meter system (125) can encompass many pipelines each with one or more MPFMs (127). Further the comprehensive flow meter system (125) can work with any MPFM (127) regardless of the vendor of the MPFM (127). Thus, when a MPFM (127) malfunctions, and the flow rates measurement at the location of the MPFM (127) is either inaccurate or non-existent, the comprehensive flow meter system (125) can detect the MPFM (127) malfunction, identify the issue with the affected MPFM (127), proactively prescribe MPFM (127) preventative maintenance actions, and provide estimated flow rates using a virtual flow meter (VFM). The flow rate data determined and output by the comprehensive flow meter system (125) may be received by a system user or an external system. For example, the flow rate data may be used by a reservoir simulator or subsurface model to optimize production of hydrocarbons from a well and/or oil and gas field. As such, the comprehensive flow meter system (125) provides accurate multiphase flow rate measurements from a well, or oil and gas field, without interruption, even when one or more MPFMs (127) are malfunctioning. Further, the comprehensive flow meter system (125) allows for proactive and intelligent scheduling of MPFM (127) maintenance activities.

FIG. 13 further depicts a block diagram of a computer system (1302) (e.g., the pressure control system) used to provide computational functionalities associated with the methods, functions, processes, flows, and procedures as described in this disclosure, according to one or more embodiments. The illustrated computer (1302) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1302) may include a computer that includes an input device, such as a keypad, keyboard, touch screen, or other device that can accept user information, and an output device that conveys information associated with the operation of the computer (1302), including digital data, visual, or audio information (or a combination of information), or a GUI.

The computer (1302) can serve in a role as a client, network component, a server, a database or other persistency, or any other component (or a combination of roles) of a computer system for performing the subject matter described in the instant disclosure. In some implementations, one or more components of the computer (1302) may be configured to operate within environments, including cloud-computing-based, local, global, or other environment (or a combination of environments).

At a high level, the computer (1302) is an electronic computing device operable to receive, transmit, process, store, or manage data and information associated with the described subject matter. According to some implementations, the computer (1302) may also include or be communicably coupled with an application server, e-mail server, web server, caching server, streaming data server, business intelligence (BI) server, or other server (or a combination of servers).

The computer (1302) can receive requests over network (1330) from a client application (for example, executing on another computer (1302) and responding to the received requests by processing the said requests in an appropriate software application. In addition, requests may also be sent to the computer (1302) from internal users (for example, from a command console or by other appropriate access method), external or third-parties, other automated applications, as well as any other appropriate entities, individuals, systems, or computers.

Each of the components of the computer (1302) can communicate using a system bus (1303). In some implementations, any or all of the components of the computer (1302), both hardware or software (or a combination of hardware and software), may interface with each other or the interface (1304) (or a combination of both) over the system bus (1303) using an application programming interface (API) (1312) or a service layer (1313) (or a combination of the API (1312) and service layer (1313). The API (1312) may include specifications for routines, data structures, and object classes. The API (1312) may be either computer-language independent or dependent and refer to a complete interface, a single function, or even a set of APIs. The service layer (1313) provides software services to the computer (1302) or other components (whether or not illustrated) that are communicably coupled to the computer (1302). The functionality of the computer (1302) may be accessible for all service consumers using this service layer. Software services, such as those provided by the service layer (1313), provide reusable, defined business functionalities through a defined interface. For example, the interface may be software written in JAVA, C++, or other suitable language providing data in extensible markup language (XML) format or another suitable format. While illustrated as an integrated component of the computer (1302), alternative implementations may illustrate the API (1312) or the service layer (1313) as stand-alone components in relation to other components of the computer (1302) or other components (whether or not illustrated) that are communicably coupled to the computer (1302). Moreover, any or all parts of the API (1312) or the service layer (1313) may be implemented as child or sub-modules of another software module, enterprise application, or hardware module without departing from the scope of this disclosure.

The computer (1302) includes an interface (1304). Although illustrated as a single interface (1304) in FIG. 13, two or more interfaces (1304) may be used according to particular needs, desires, or particular implementations of the computer (1302). The interface (1304) is used by the computer (1302) for communicating with other systems in a distributed environment that are connected to the network (1330). Generally, the interface (1304) includes logic encoded in software or hardware (or a combination of software and hardware) and operable to communicate with the network (1330). More specifically, the interface (1304) may include software supporting one or more communication protocols associated with communications such that the network (1330) or interface's hardware is operable to communicate physical signals within and outside of the illustrated computer (1302).

The computer (1302) includes at least one computer processor (1305). Although illustrated as a single computer processor (1305) in FIG. 13, two or more processors may be used according to particular needs, desires, or particular implementations of the computer (1302). Generally, the computer processor (1305) executes instructions and manipulates data to perform the operations of the computer (1302) and any algorithms, methods, functions, processes, flows, and procedures as described in the instant disclosure.

The computer (1302) also includes a memory (1306) that holds data for the computer (1302) or other components (or a combination of both) that can be connected to the network (1330). The memory may be a non-transitory computer readable medium. For example, memory (1306) can be a database storing data consistent with this disclosure. Although illustrated as a single memory (1306) in FIG. 13, two or more memories may be used according to particular needs, desires, or particular implementations of the computer (1302) and the described functionality. While memory (1306) is illustrated as an integral component of the computer (1302), in alternative implementations, memory (1306) can be external to the computer (1302).

The application (1307) is an algorithmic software engine providing functionality according to particular needs, desires, or particular implementations of the computer (1302), particularly with respect to functionality described in this disclosure. For example, application (1307) can serve as one or more components, modules, applications, etc. Further, although illustrated as a single application (1307), the application (1307) may be implemented as multiple applications (1307) on the computer (1302). In addition, although illustrated as integral to the computer (1302), in alternative implementations, the application (1307) can be external to the computer (1302).

There may be any number of computers (1302) associated with, or external to, a computer system containing computer (1302), wherein each computer (1302) communicates over network (1330). Further, the term “client,” “user,” and other appropriate terminology may be used interchangeably as appropriate without departing from the scope of this disclosure. Moreover, this disclosure contemplates that many users may use one computer (1302), or that one user may use multiple computers (1302).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for determining phase flow rates of a multiphase fluid flowing in a pipeline of a well, the method comprising:
receiving multiphase flow meter (MPFM) diagnostic inputs from a MPFM disposed on the pipeline;
receiving a first phase flow rates measurement from the MPFM;
receiving virtual flow meter (VFM) inputs from a plurality of field devices disposed on the pipeline;
determining, with a first model, a state of the MPFM, wherein the first model processes the MPFM diagnostic inputs;
determining, with a second model, a second phase flow rates measurement, wherein the second model processes the VFM inputs;
setting a determined phase flow rates measurement to the first phase flow rates measurement if the state of the MPFM is determined not to be in fault, otherwise, setting the determined phase flow rates measurement to the second phase flow rates measurement; and
adjusting one or more field devices in the plurality of field devices to optimize production of the well based on the determined phase flow rates measurement.

2. The method of claim 1, wherein the first model and the second model are machine-learned models.

3. The method of claim 1, wherein the multiphase fluid is composed of water, oil, and gas.

4. The method of claim 1, wherein the MPFM diagnostic inputs comprise gamma counts, supplied voltage, Venturi differential pressure, and flow computer temperature.

5. The method of claim 1, wherein the VFM inputs comprise wellhead pressure, upstream wellhead temperature, downstream wellhead pressure, Venturi differential pressure, choke valve position, electrical submersible pump (ESP) frequency, and ESP motor current.

6. The method of claim 1, further comprising recommending maintenance for the MPFM based on, at least in part, the first model.

7. The method of claim 1, further comprising generating an alarm for the MPFM based on, at least in part, the first model.

8. The method of claim 1, further comprising transmitting the phase flow rates to an external system.

9. The method of claim 6, further comprising performing the recommended maintenance on the MPFM.

10. The method of claim 7, further comprising determining a priority for the alarm.

11. A comprehensive flow meter system, comprising:
a plurality of field devices disposed on a pipeline of a well, wherein a multiphase fluid flows through the pipeline;
a multiphase flow meter (MPFM) disposed on the pipeline, wherein the MPFM produces a first phase flow rates measurement;
a MPFM diagnostic tool, comprising:
a first model, wherein the first model is configured to process MPFM diagnostic inputs from the MPFM and determine a state of the MPFM;
an alarm generator; and
a maintenance recommender;
a virtual flow meter (VFM), comprising:
a second model, wherein the second model is configured to process field data from the plurality of field devices and determine a second phase flow rates measurement; and
a computer comprising:
one or more computer processors, and
a non-transitory computer-readable medium with instructions stored thereon, the instructions, when executed by the one or more computer processors, causing the computer to perform:
receiving MPFM diagnostic inputs from the MPFM;
receiving the first phase flow rates measurement from the MPFM;
receiving the field data from the plurality of field devices;
determining, with the first model, the state of the MPFM;
determining, with the second model, the second phase flow rates measurement;
wherein, if the state of the MPFM is determined not to be in fault, returning the first phase flow rates measurement as a determined phase flow rates measurement for the multiphase fluid, otherwise returning the second phase flow rates measurement as the determined phase flow rates measurement for the multiphase fluid; and
adjusting one or more field devices in the plurality of field devices to optimize production of the well based on the determined phase flow rates measurement.

12. The system of claim 11, wherein the first model and the second model are machine-learned models.

13. The system of claim 11, wherein the multiphase fluid is composed of water, oil, and gas.

14. The system of claim 11, wherein the MPFM diagnostic inputs comprise gamma counts, supplied voltage, Venturi differential pressure, and flow computer temperature.

15. The system of claim 11, wherein the field data comprise wellhead pressure, upstream wellhead temperature, downstream wellhead pressure, Venturi differential pressure, choke valve position, electrical submersible pump (ESP) frequency, and ESP motor current.

16. The system of claim 11, wherein the computer-readable medium further comprises instructions for recommending maintenance for the MPFM based on, at least in part, the first model.

17. The system of claim 11, wherein the computer-readable medium further comprises instructions for generating an alarm for the MPFM based on, at least in part, the first model.

18. The system of claim 11, wherein the computer-readable medium further comprises instructions for transmitting the phase flow rates to an external system.

19. The system of claim 17, wherein the computer-readable medium further comprises instructions for determining a priority for the alarm.

20. The system of claim 11, further comprising an in-production validator, wherein the in-production validator compares the first phase flow rates measurement to the second phase flow rates measurement when the state of the MPFM is determined not to be in fault.
